(19) United States
(12) Patent Application Publication
(10) Pub. No.: US 2005/0163325 A1
(43) Pub. Date: Jul. 28, 2005

(54) Method for characterizing a sound signal

(76) Inventors: Xavier Rodet, Fontenay-Sous-Bois (FR); Laurent Worms, Velizy-Villacoublay (FR); Geoffroy Peeters, Paris (FR)

Correspondence Address: Laurent WORMS, 2, Square Racan, Paris, 75016, FR

(21) Appl. No.: 10/500,441

(22) PCT Filed: Dec. 24, 2002
(86) PCT No.: PCT/FR02/04549

(30) Foreign Application Priority Data
Dec. 27, 2001 (FR) 0116949

(51) Int. Cl. H04R 29/00

(52) U.S. Cl. 381/56

(57) ABSTRACT

The invention concerns a method for characterizing in accordance with specific parameters, a sound signal x(t) varying in time t in different frequency bands k, and referenced x(k, t). It consists in storing the signal x(t), calculating and storing the energy E(k, t) of said signal x(k, t) for each of said bands k, k varying from 1 to K and in accordance with a time window h(t) of duration 2N, and in a second step, calculating the energy variation and the signal phase E(k, t) in J frequency bands, the J values referenced F(j, k, t) and φ(j, k, t) thus obtained constituting the specific parameters of an extract of duration 2N of the sound signal x(t) and in repeating said calculation at every S time interval.

The invention relates to a method for characterizing, according to specific parameters, a sound signal developing over time in different frequency bands.

The field of the invention is that of sound signal recognition applied in particular to the identification of musical works used without authorization.

In fact, the development of methods of digitizing and multimedia have caused a considerable increase in such fraudulent uses. The result is a new problem for those agencies charged with collecting royalties, since there must be some way to identify these uses, especially on the interactive digital networks such as the Internet, in order to satisfactorily assess and to distribute the compensation due to the authors of these musical works.

Consequently, in order not to be limited to musical works, a sound signal is more generally considered.

The object of the present invention is then to create a database of sound signals, each sound signal being characterized by one fingerprint such that being given a unknown sound signal that is characterized in this same fashion, a search can be executed and a rapid comparison of the fingerprint of said unknown signal made with the universe of fingerprints in the database.

The fingerprint is constituted of specific parameters determined in the following fashion.

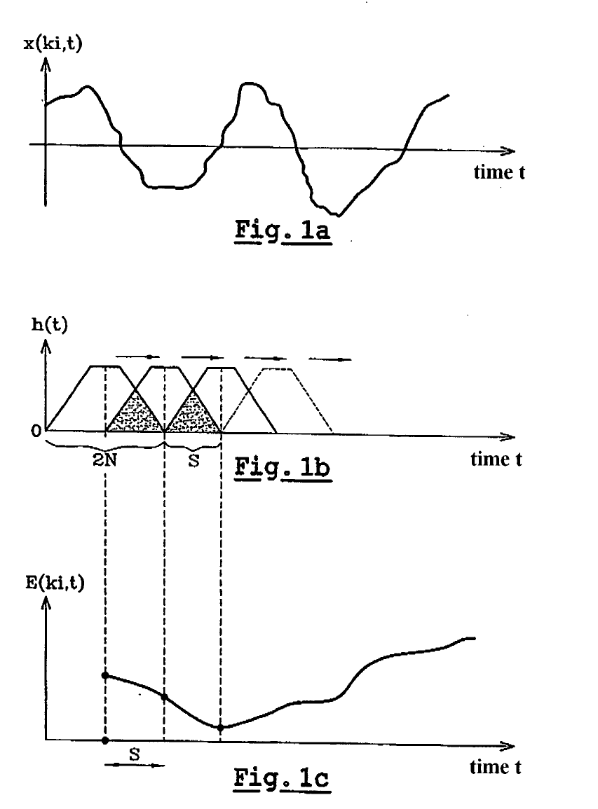

In a first step, the sound signal is broken down in that its amplitude x(t) varies with time t, according to different frequency bands k: x(k, t) is the amplitude of the sound signal filtered into the frequency band k and represented in FIG. 1a.

As represented in FIG. 1c, the short-term energy E(k, t) of this filtered sound signal is calculated using a window h(t) represented in FIG. 1b, having a support of 2N seconds. This calculation is repeated by sliding said window every S seconds.

These values E(k, t) constitute the specific parameters of an extract of 2N seconds of the sound signal x(k, t) in the frequency band k.

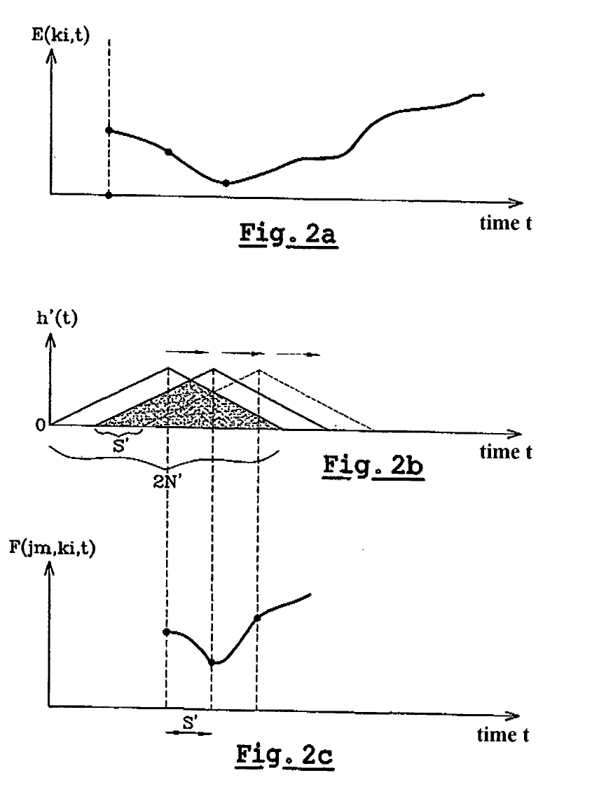

Other parameters can be obtained by calculating the energy of E(k, t) for the different frequency bands j by using a window h′(t) represented in FIG. 2b, having a base of 2N′ seconds; this calculation is reiterated by sliding said window every S′ seconds: one then obtains F(j, k, t) represented in FIG. 2. These F(j, k, t) values are standardized with respect to their maximum in order to make them independent of the amplitude of the sound signal.

Thus standardized, these values constitute specific parameters of an extract of 2N′ seconds of the sound signal x(k, t) in the k band of frequencies.

One can also calculate the phase of E(k, t) for different bands of frequencies j: one obtains P(j, k, t). The P(j, k, t) values are standardized with respect to a reference value P(1, j, t) and one then obtains other specific parameters of an extract of 2N′ seconds of sound signal.

Other parameters can be added such as the mean value of the E(k, t) energy.

The object of the invention is a method for characterizing in accordance with specific parameters a sound signal x(t) evolving according to the time t over a duration D in different bands of frequencies k and then written x(k, t), principally characterized in that it consists of storing the signal x(t), calculating the energy E(k, t) of said signal x(k, t) for each of said bands of frequencies k, k varying from 1 to K and according to a temporal window h(t) of a duration of 2N, storing the values of the energy E(k, t) obtained, these values constituting the specific parameters of an extract of a duration of 2N of the sound signal x(t) and reiterating this calculation at regular intervals, in order to obtain the universe of specific parameters for the duration D of the sound signal x(t).

In addition, it consists of calculating and storing the energy F(k, j, t) of E(k, t) for the bands of frequencies j, j varying from 1 to J, according to a temporal window h′ (t) of a duration of 2N′, the J×K values of the energy F(j, k, t) obtained constitute the specific parameters of an extract of a duration of 2N′ of the sound signal x(t) and reiterating this calculation at regular intervals, in order to obtain the universe of specific parameters for the duration D of the sound signal x(t).

It may consist of calculating the phase P(j, k, t) of the energy E(k, t) for the bands of frequencies j, j varying from 1 to J with j being different from k, and including the values of the phase P(j, k, t) obtained among the specific parameters of the sound signal x(t).

It can also consist of calculating the mean value of the energy E(k, t) over 2N′ seconds for each frequency band j, in reiterating this calculation at regular intervals, in order to obtain the universe of specific parameters for the duration D of the sound signal x(t) and including the mean values so obtained among the specific parameters of the sound signal x(t).

According to one feature, it consists of taking into account the specific parameters of a sound signal x(t) as the components of a vector representing x(t), of positioning the vectors in a space of as many dimensions as there are parameters, of defining classes including the most proximate vectors and of recording said classes.

The classes having inter-class distances and intra-class distances, the method consists advantageously of selecting from among the specific parameters those parameters making it possible to obtain the relatively large inter-class distances with respect to of the intra class distances and of recording the selected parameters.

The invention relates also to a device for identifying a sound signal, characterized in that it comprises a database service comprising means for implementing the method for characterizing a sound signal according to specific parameters as described hereinbefore and the means for executing a search for said signal in the database.

Preferably, the search means comprise means for directly recognizing the class to which said sound signal belongs and means for executing a search for the class by comparison of the specific parameters of the unknown sound signal with those of the database, the class being chosen, for example, using the method of the nearest neighbor algorithm.

Other characteristics and advantages of the invention will become more apparent when reading the description provided by way of example and non-limitingly and with reference to the appended drawings, wherein:

FIGS. 1a, 1b and 1c represent, respectively, the diagrammatic plottings of the variation of a sound signal x(kᵢ, t) filtered into a band of frequencies kᵢ, a Hamming window h(t) and the short-term energy E(kᵢ, t) of the signal x(kᵢ, t);

FIGS. 2a, 2b and 2c represent, respectively the diagrammatic plottings of the variation of energy E(kᵢ, t) for the frequency band kᵢ, a Hamming windos h′(t) and the energy F(jₘ, kᵢ, t) of E(kᵢ, t) for the band of frequencies jₘ.

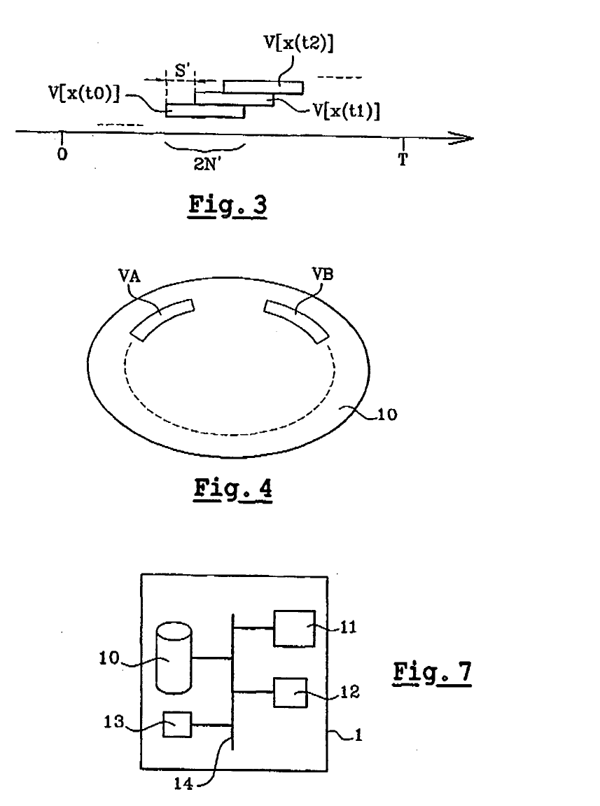

FIG. 3 diagrammatically represents the universe of vectors V[x(t)] constituting the fingerprint of a signal x(k, t);

FIG. 4 diagrammatically represents the storing of fingerprints;

FIG. 5 represents the classification of the sound signals according to two parameters;

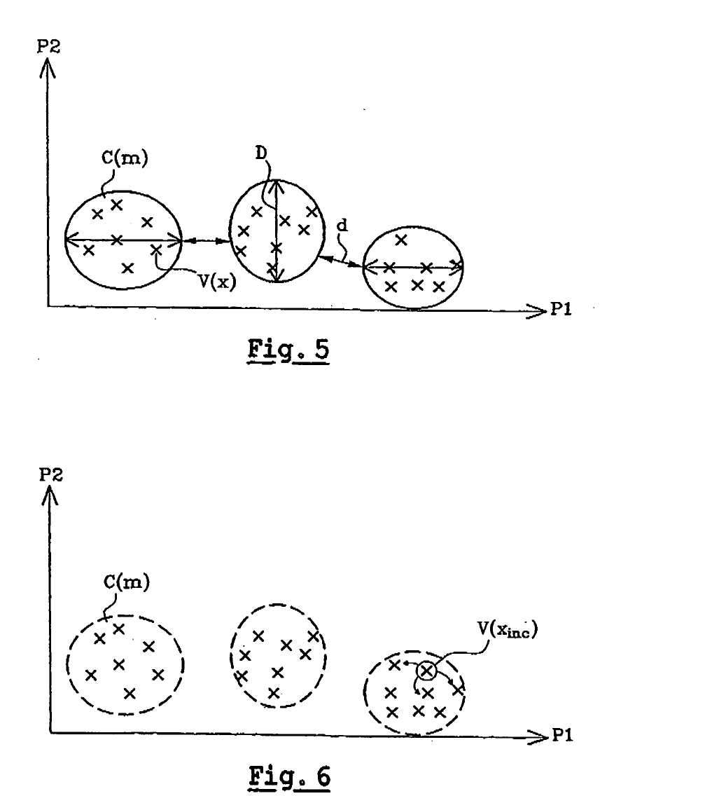

FIG. 6 represents a method for searching for a sound signal using the method of the nearest neighbor algorithm;

FIG. 7 diagrammatically represents a database service for storing the fingerprints of the sound signals.

The sound signals that are processed according to this method of characterization are recorded sound signals, particularly on compact disks.

In the following, it will be considered that the sound signal x(t) is a digital signal sampled at a sampling frequency of fₑ, for example 11,025 Hz corresponding to one quarter of the current sampling frequency for compact disks, which is 44,100 Hz.

Therefore, an analog sound signal can be characterized: it must first be converted into a digital signal by means of an analog—digital converter.

The sound signal x(k, t) represented in FIG. 1a for k=kᵢ is thus a digital signal sampled at the frequency fe and obtained after filtering into a band of frequencies kᵢ. Each value of this digital signal sampled is coded, for example, in 16 bits. The bands of frequencies are bands of the audible spectrum varying from approximately 20 Hz to 20 kHz and sectioned into K (k varies from 1 to K) bands of frequencies, K=127, for example.

The short-term energy E(k, t) represented in FIG. 1c for k=kᵢ is calculated using a window h(t) of 2N seconds; for example, a Hamming window having a base of approximately 23 ms represented in FIG. 1b.

E(k, t) is the square of the module of a transformation of the sound signal sampled x(t) in the time—frequency plan or in the time—scale plan. Among the transformations that can be utilized are the Fourier transformation, the cosine transformation, the Hartley transformation and the wavelet transformation. A bank of band-pass filters also does this type of transformation. The short-term Fourier transformation makes possible a time—frequency representation adapted to the musical signal analysis. Accordingly, the energy E(k, t) is written:

$$E ( k , t ) = {\vert {\sum }_{n = - N}^{n = N} x ( t + n / {f}_{e} ) \cdot h ( n / {f}_{e} ) \cdot {ⅇ}^{- 4 ⅈ π k n / N} \vert}^{2}$$

wherein i such that i²=−1

One slides the window over the sound signal every S seconds; for example, every 10 ms. E(k, t) will thus be sampled every 10 ms: E(k, t₀), E(k, t₁) with t₁=to +10 ms, etc. will be obtained.

Thus, all of the S seconds of the sound signal x(t) will be coded by a vector having K components E(k, t), each of these components coding for the energy of 23 ms or the sound signal x(t) in K bands of frequencies.

Other parameters are obtained by reproducing in any fashion the aforementioned calculations and applying them each time to E(k, t) as represented n FIGS. 2a to 2c.

The energy E(k, t) is filtered into J different bands of frequencies: E(j, k, t) is the energy E(k, t) filtered into the band of frequencies j, j varying from 1 to J with, for example, J=51.

Then F(j, k, t) is calculated, represented in FIG. 2c), for k=kᵢ and j=jₘ, using a window h′ (t) of 2N′ seconds; for example a Hamming window having a base of 10 s. Thus, using i such that i²=−1, one can write

$$F ( j , k , t ) = {\vert {\sum }_{n = - {N}^{′}}^{n = {N}^{′}} E ( k , t + n / {f}_{{e}^{′}} ) \cdot {h}^{′} ( n / {f}_{{e}^{′}} ) \cdot {ⅇ}^{- 4 ⅈ π j n / {N}^{′}} \vert}^{2}$$

In our example, every seconds (S′=1), the sound signal x(t) is coded by 127×51 parameters F(j, k, t), each real F(j, k, t) representing the energy of ten seconds (2N′=10) of the energy signal E(k, t) in the frequency band j.

In order to make F(j, k, t) independent of the amplitude of the signal that can be more or less strong, these values are put in relation to a reference value; in the present case, the maximum value of F_{M}(j, k, t) for all of the k and j taken into account. Thus K×J parameters are obtained F(j, k, t)/F_{M}(j, k, t).

In addition, the phase of the energy E(k, t) in each of the bands of frequency j is calculated every 2N′ seconds: P(j, k, t).

To do this, the argument of the Fourier transformation of E(k, t) in each of the frequency bands j is calculated:

$$P ( j , k , t ) = Arg \vert {\sum }_{n = - {N}^{′}}^{n = {N}^{′}} E ( k , t + n / {f}_{{e}^{′}} ) \cdot {h}^{′} ( n / {f}_{{e}^{′}} ) \cdot {ⅇ}^{- 4 ⅈ π j n / {N}^{′}} \vert$$

As above, these values are put in relation to a reference value; in the present case, the value of P(j, k, t) for the second band of frequencies (j=1) considered, because the temporal reference of the sample is unknown: the origin of the time is unknown.

To do this, the phases yielded φ(j, k, t) are calculated using the following formulae

$$φ ( l , k , t ) = P ( l , k , t )$$

$$φ ( j , k , t ) = P ( j , k , t ) - P ( l , k , t ) \cdot \frac{f ( k )}{f ( 1 )} , for k > 1$$

wherein the f(k) are the central frequencies of channels k.

Thus, K×J parameters corresponding to the values of the yielded phase φ(j, k, t) are obtained.

Other parameters can also be taken into account; in particular, the mean values of the energy E(k, t) over 2N′ seconds and this for each band of frequencies j: E(j, k, t).

The universe of these standardized parameters define at regular intervals a fingerprint that can be considered as a vector V(x(t)). The universe of the standardized parameters, for example, F(j, k, t)/F_{M} and P(j, k, t)−P(j, 1, t) define every S′ seconds a fingerprint that can be considered as a vector V(x(t)) having 2×K×J dimensions (2×127×51) or about 13,000 in our example), one dimension per parameter, each vector characterizing an extract of 2N′ seconds of the sound signal x(t), 10 seconds in our example.

This characterization is reiterated every S′ seconds, every second for example (S′=1).

As represented in FIG. 3, a signal x(t) over T seconds is ultimately characterized by L vectors V, L being approximately equal to T/S′.

For a sound signal lasting 10 nm or 600 s, 600 vectors are obtained; that is, 600×2×J×K parameters.

These vectors are stored in the storage zone 10 of a database housed on a server or on a compact disk. FIG. 4 represents the universe of the vectors V of a signal or of a work A by VA, likewise VB for a work B, etc.

It is desirable to reduce the number of components of these vectors; in other words, the number of parameters in order to obtain a vector or a fingerprint of a more reduced size in view of its storage in the database. Furthermore, when it is a question of comparing the fingerprint of an unknown sound signal to those in the database, it is desirable that the number of parameters to be compared be reduced in order that said search can be executed quickly.

Now, these parameters do not all contain the same quantity of information; certain ones can be redundant or useless. That is why one selects the most meaningful parameters from among all parameters, using a mutual information calculation presented in the publication PROC. ICASSP '99, Phoenix, Ariz., USA, March 1999H. YANG, S. VAN VUUREN, H. HERMANSKY, “Relevancy of Time—Frequency Features for Phonetic Classification Measured by Mutual Information”. Thus, K to K₁ and J to J₁ are limited.

A method for selecting these parameters will now be presented.

Each of the fingerprints of these sound signals; that is, each of these vectors is classified into a space R to N dimensions, N being the number of components of the vectors. For the sake of simplicity, an example of classification for vectors having 2 dimensions P1 and P2 is represented in FIG. 5.

The classes C(m) are defined by grouping the vectors by proximity, m varying from 1 to M. For example, one can decide that one class corresponds to one musical work: in this case M is the number of musical works stored in the database.

The result of the mutual information calculation between these classes C(m) and the parameters is that the relevance of the parameters is linked to the inter and intra class distances: relevant parameters assuring relatively large inter-class distances d compared to the intra-class distances D.

By keeping only the relevant parameters, K₁ and J₁ are thus defined.

For example, one can consider five (K₁=5) bands of frequencies centered on 344 Hz, 430 Hz, 516 Hz, 608 Hz and 689 Hz, respectively.

Tests have been done by taking J₁=3.

The classes C(m) are thus constituted using the vectors V_{q}(x) not comprising more than 2×K₁×J₁ components.

An example will be given for K₁=5 and J₁=3, of the size of the memory of a database containing 1,000 hours of music and by taking into account as parameters E(k, t) and F(j, k, t), each of these parameters being coded using 4 bytes.

The E(k, t) parameters calculated every 10 ms occupy 1,000×3,600×100×4 bytes or apprximately 7 gigabytes.

The parameters F(j, k, t) calculated every second occupy 1,000×3,600×3×5×4 bytes or approximately 200 megabytes.

These parameters are associated with sound signal references: if one considers that the references contain 100 characters each coded on one byte, these references occupy 1,000×10×100 bytes or approximately 1 megabyte.

Such a database would ultimately occupy approximately 7 gigabytes.

When one wishes to identify an unknown sound signal, one first of all establishes the fingerprint, referenced V(xinc) in FIG. 6, as described hereinbefore, knowing that the unknown sound signal can be a complete musical work or an extract therefrom.

The search for the class of this fingerprint in the database thus consists, according to a classical method illustrated in FIG. 6, of comparing the parameters of this fingerprint V(xinc) to those of the fingerprints of the database. The most proximate fingerprints, called the nearest neighbors, define the class in the following fashion: the class is that of the majority of the nearest neighbors.

A database server 1 is diagrammatically represented in FIG. 7. It comprises a storage zone 10 for the data of the database, in which the fingerprints of the mixed sound signals are stored by their references. In addition, it comprises a memory 11, the aforementioned characterization and programs are stored, a processor 12 with working memories for deploying the programs. It obviously comprises an I/O interface 13 and a bus 14 connecting these diverse elements with each other.

When entering new sound signals into the database 1, the interface 13 receives the signal x(t) accompanied by its references; if it is only an unknown signal to be identified, the interface 12 receives only the unknown signal x(t).

Upon output, the interface 13 provides a response to the search for an unknown signal. This response is negative if the unknown signal does not exist in the storage zone 10; if the signal has been identified, the response includes the references of the identified signal.

1-8. (canceled)

9. A method for characterizing, according to specific parameters, a sound signal x(t) evolving over the time t during a duration D into different bands of frequencies k and then recorded x(k, t), comprising:
storing the signal x(t),
calculating and storing the energy E(k, t) of said signal x(k, t) for each of said bands of frequencies k, k varying from 1 to K and according a temporal window h(t) of a duration of 2N,
calculating and storing the energy F(k, j, t) and the related phase φ(j, k, t) of E(k, t) for the bands of frequencies j, j varying from 1 to J,
using a temporal window h′(t) of a duration of 2N′, the J×K values of the energy F(j, k, t) and of the related phase φ(j, k, t) thus obtained constituting the specific parameters of an extract of a duration of 2N′ of the sound signal x(t), and
reiterating said calculation at regular intervals in order to obtain the universe of the specific parameters for the duration D of the sound signal x(t).

10. The method according to claim 9, further comprising:
calculating for each frequency band j the mean value of the energy E(k, t) over 2N′ seconds,
reiterating said calculation at regular intervals in order to obtain the universe of specific parameters for the duration D of the sound signal x(t), and
including the mean values obtained among the specific parameters of the sound signal x(t).

11. The method according to claim 9, further comprising:
taking into account the specific parameters of a sound signal x(t) as the components of a vector representative of x(t),
positioning the vectors in a space of as many dimensions as there are parameters,
defining the classes grouping the most proximate vectors, and
recording said classes.

12. The method according to claim 9, wherein the classes have inter-class distances and intra-class distances, and further comprising:
selecting from among the specific parameters, those parameters making it possible to obtain relatively large inter-class distances vis-à-vis the intra-class distances, and
recording the selected parameters.

13. A device for identifying a sound signal, comprising:
a database server comprising means for implementing the method for characterizing a sound signal according to specific parameters according to claim 9, and
means for searching for said sound signal in the database.

14. A device for identifying a sound signal, comprising:
a database server comprising means for implementing the method for characterizing a sound signal according to specific parameters according to claim 11, and
means for searching for said sound signal in the database,
wherein the means for searching comprise means for recognizing the class to which said sound signal belongs and the means for comparing, by the method of the nearest neighbor algorithm, specific parameters of the unknown sound signal with the specific parameters of the database.

15. A device for identifying a sound signal, comprising:
a database server comprising means for implementing the method for characterizing a sound signal according to specific parameters according to claim 12, and
means for searching for said sound signal in the database,
wherein the means for searching comprise means for recognizing the class to which said sound signal belongs and the means for comparing, by the method of the nearest neighbor algorithm, specific parameters of the unknown sound signal with the specific parameters of the database.
